(19) United States
(12) Patent Application Publication
(10) Pub. No.: US 2017/0270923 A1
(43) Pub. Date: Sep. 21, 2017

(54) VOICE PROCESSING DEVICE AND VOICE PROCESSING METHOD

(71) Applicant: HONDA MOTOR CO., LTD., Tokyo (JP)

(72) Inventors: Shunichi Yamamoto, Wako-shi (JP); Naoaki Sumida, Wako-shi (JP); Hiroshi Kondo, Wako-shi (JP); Asuka Shiina, Wako-shi (JP); Kazuhiro Nakadai, Wako-shi (JP); Keisuke Nakamura, Wako-shi (JP)

(21) Appl. No.: 15/444,553

(22) Filed: Feb. 28, 2017

(30) Foreign Application Priority Data
Mar. 15, 2016 (JP) 2016-051137

(51) Int. Cl. G10L 15/22; G10L 15/10; G10L 15/02

(52) U.S. Cl. CPC G10L 15/22; G10L 15/02; G10L 15/10; G10L 2015/025; G10L 13/043

(57) ABSTRACT

A voice recognizing portion recognizes a voice and generates a phoneme string, and a storage portion stores a first name list indicating phoneme strings of first names and a second name list obtained by associating a phoneme string of a predetermined first name among the first names with a phoneme string of a second name similar to the phoneme string of the first name. A name specifying portion specifies a name indicated by the voice on the basis of the first name list. A checking portion selects a phoneme string of a second name corresponding to a phoneme string of the name specified by the name specifying portion by referring to the second name list when a user answers that the name specified by the name specifying portion is not the correct name.

### CROSS-REFERENCE TO RELATED APPLICATION

Priority is claimed on Japanese Patent Application No. 2016-051137, filed Mar. 15, 2016, the content of which is incorporated herein by reference.

### BACKGROUND OF THE INVENTION

Field of the Invention

The present invention relates to a voice processing device and a voice processing method.

Description of Related Art

Voice recognition technologies are applied to operation instructions or searching for a family name, a given name, and the like. For example, Japanese Unexamined Patent Application, First Publication No. 2002-108386 describes a method of recognizing a voice and an in-vehicle navigation device to which the method is applied, in which, when a voice is recognized by matching a result of analyzing a frequency of a voice for an input word with a word dictionary created using a plurality of recognition templates, a plurality of restarts are allowed when erroneous recognition occurs, and a recognition template used up to that point is replaced with another recognition template when erroneous recognition occurs even after the specific number of restarts are performed and the voice recognition task is performed again.

### SUMMARY OF THE INVENTION

Such a voice recognition method is considered to include recognizing the name of a called person serving as a calling target from an utterance of a visitor serving as a user and applying it to a reception robot having a function of calling the called person. The reception robot plays a check voice used to check the recognized name and recognizes an affirmative utterance or a negative utterance corresponding to the check voice or a corrected utterance in which the name of the called person is uttered again from the utterance of the user. However, there is a concern that erroneous recognition is repeated even in the titles with a phoneme string of which a distance between phonemes is small also in the above-described voice recognition method. For example, when the user wants to call (Mr./Ms.) ONO (a Japanese family name) (a phoneme string: ono) as a called person, ONO may be erroneously recognized in some cases as OONO (a Japanese family name) (a phoneme string: o:no) having a phoneme string with a short distance from a phoneme of the phoneme string of ONO. In this case, no matter how many times the user utters it, ONO is erroneously recognized as OONO. Thus, playing of a check voice (for example, “o:no?”) of a recognition result by the reception robot and an utterance (for example, “ono”) used to correct the check voice by the user are repeated. For this reason, it may be difficult to specify the name intended by the user.

Aspects related to the present invention were made in view of the above-described circumstances, and an object of the present invention is to provide a voice processing device and a voice processing method which are capable of smoothly specifying the name intended by the user.

In order to accomplish the object, the present invention adopts the following aspects.

(1) A voice processing device of one aspect of the present invention includes: a voice recognizing portion configured to recognize a voice and to generate a phoneme string; a storage portion configured to store a first name list indicating phoneme strings of first names and a second name list obtained by associating a phoneme string of a predetermined first name among the first names with a phoneme string of a second name similar to the phoneme string of the first name; a name specifying portion configured to specify a name indicated by the voice on the basis of a degree of similarity between the phoneme string of the first name and the phoneme string generated by the voice recognizing portion; a voice synthesizing portion configured to synthesize a voice of a message; and a checking portion configured to cause the voice synthesizing portion to synthesize a voice of a check message used to request an answer regarding whether the name specified by the name specifying portion is a correct name, wherein the checking portion causes the voice synthesizing portion to synthesize the voice of the check message with respect to the name specified by the name specifying portion, when a user answers that the name specified by the name specifying portion is not the correct name, a phoneme string of a second name corresponding to a phoneme string of the name specified by the name specifying portion is selected by referring to the second name list, and the voice synthesizing portion is caused to synthesize the voice of the check message with respect to the selected second name.

(2) In an aspect of (1), a phoneme string of a second name included in the second name list may be a phoneme string with a possibility of causing the phoneme string of the second name to be erroneously recognized as the phoneme string of the first name higher than a predetermined possibility.

(3) In an aspect of (1) or (2), a distance between the phoneme string of the second name associated with the phoneme string of the first name in the second name list and the phoneme string of the first name may be shorter than a predetermined distance.

(4) In an aspect of (3), the checking portion may preferentially select the second name related to a phoneme string in which the distance from the phoneme string of the first name is small.

(5) In an aspect of (3) or (4), the phoneme string of the second name may be obtained according to at least one of substitution of some of phonemes constituting the phoneme string of the first name with other phonemes, insertion of other phonemes, and deletion of some of the phonemes as elements of erroneous recognition of the phoneme string of the first name, and the distance may be calculated to accumulate a cost related to the elements.

(6) In an aspect of (5), the cost may be set so that a value thereof decreases as a number of the elements of erroneous recognition increases.

(7) A voice processing method of one aspect of the present invention is a voice processing method in a voice processing device including a storage portion configured to store a first name list indicating phoneme strings of first names and a second name list obtained by associating a phoneme string of a predetermined first name among the first names with a phoneme string of a second name similar to the phoneme string of the first name, wherein the voice process device has: a voice recognition step of recognizing a voice and generating a phoneme string; a name specifying step of specifying a name indicated by the voice on the basis of a degree of similarity between the phoneme string of the first name and the phoneme string generated in the voice recognition step; and a check step of causing a voice synthesizing portion to synthesize a voice of a check message used to request an answer regarding whether the name specified in the name recognition step is a correct name, and the check step has: a step of causing the voice synthesizing portion to synthesize the check message with respect to the name specified in the name recognition step; a step of selecting a phoneme string of a second name corresponding to a phoneme string of the name specified in the name recognition step by referring to the second name list when a user answers that the name specified in the name recognition step is not the correct name; and a step of causing the voice synthesizing portion to synthesize the voice of the check message with respect to the selected second name.

According to an aspect of (1) or (7), the name similar in pronunciation to a recognized name is selected by referring to the second name list. Even if the recognized name is disaffirmed by the user, the selected name is presented as the candidate for the name intended by the user. For this reason, the name intended by the user is highly likely to be specified quickly. Also, the repetition of the playing of the check voice of the recognition result and the utterance used to correct the check result is avoided. For this reason, the name intended by the user is smoothly specified.

In the case of (2), even if the uttered name is erroneously recognized as the first name, the second name is selected as the candidate for the specified name. For this reason, the name intended by the user is highly likely to be specified.

In the case of (3), the second name with pronunciation which is quantitatively similar in pronunciation to the first name is selected as the candidate for the specified name. For this reason, the name similar in pronunciation to the name which is erroneously recognized is highly likely to be specified as the name intended by the user.

In the case of (4), in addition, when there are a plurality of second names corresponding to the first name, one of the second names which is similar in pronunciation to the first name is preferentially selected. Since the name similar in pronunciation to the name which is erroneously recognized is preferentially presented, the name intended by the user is highly likely to be specified early.

In the case of (5), in addition, a small distance is calculated because a change in a phoneme string according to erroneous recognition is simple. For this reason, the name similar in pronunciation to the name which is erroneously recognized is quantitatively determined.

In the case of (6), in addition, the name related to the phoneme string highly likely to be erroneously recognized as the phoneme string of the first name is selected as the second name. For this reason, the name intended by the user is highly likely to be specified as the second name.

### BRIEF DESCRIPTION OF THE DRAWINGS

FIG. 1 is a block diagram showing a constitution of a voice processing system related to this embodiment.

FIG. 2 is a view illustrating an example of phoneme recognition data related to this embodiment.

FIG. 3 is a view illustrating an example of cost data related to this embodiment.

FIG. 4 is a view illustrating a calculation example (1) of an editing distance related to this embodiment.

FIG. 5 is a view illustrating a calculation example (2) of an editing distance related to this embodiment.

FIG. 6 is a view illustrating a calculation example (3) of an editing distance related to this embodiment.

FIG. 7 is a view illustrating a calculation example (4) of an editing distance related to this embodiment.

FIG. 8 is a flowchart illustrating an example of a process of generating a second name list related to this embodiment.

FIG. 9 is a view illustrating an example of a first name list related to this embodiment.

FIG. 10 is a view illustrating an example of a second name list related to this embodiment.

FIG. 11 is a flowchart showing an example of a voice process related to this embodiment.

FIG. 12 is a flowchart showing a portion of a checking process related to this embodiment.

FIG. 13 is a flowchart showing another portion of a checking process related to this embodiment.

FIG. 14 is a view illustrating an example of a message or the like related to this embodiment.

FIG. 15 is a block diagram showing a voice processing system related to one modified example of this embodiment.

### DETAILED DESCRIPTION OF THE INVENTION

### First Embodiment

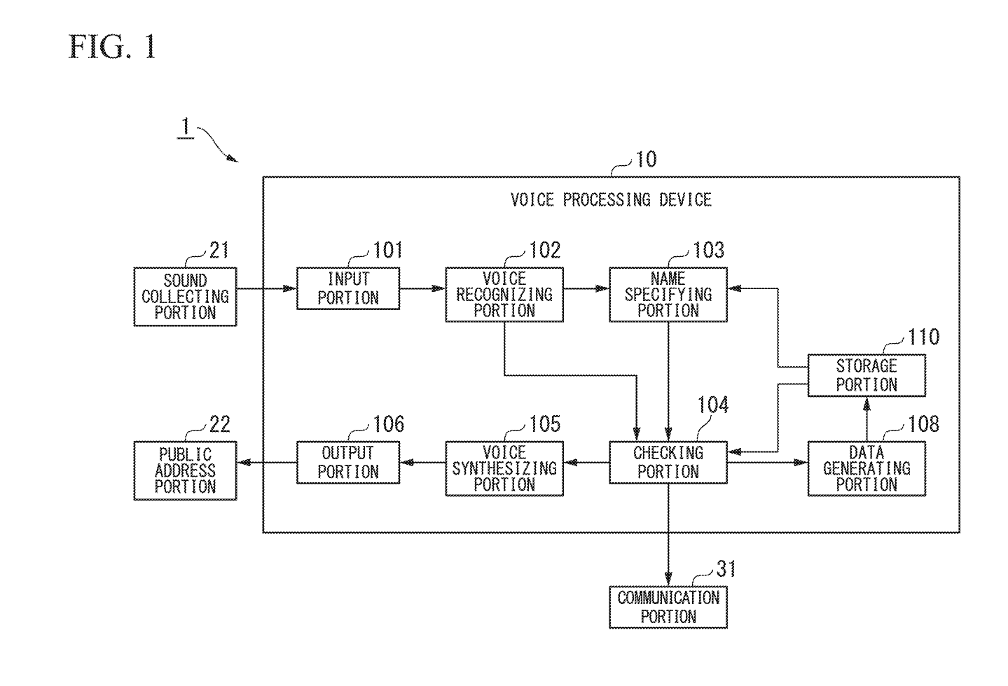

Hereinafter, an embodiment of the present invention will be described in detail with reference to the drawings. FIG. 1 is a block diagram showing a constitution of a voice processing system 1 related to this embodiment.

The voice processing system 1 related to this embodiment includes a voice processing device 10, a sound collecting portion 21, a public address portion 22, and a communication portion 31.

The voice processing device 10 recognizes a voice indicated by voice data input from the sound collecting portion 21 and outputs voice data indicating a check message used to request an answer regarding whether a recognized phoneme string is content intended by a speaker to a public address portion 22. A phoneme string of a check target includes a phoneme string indicating pronunciation of the name of a called person serving as a calling target. Also, the voice processing device 10 performs or controls an operation corresponding to the recognized phoneme string. The operation to be performed or controlled includes a process of calling the called person, for example, a process of starting communication with a communication device used by the called person.

The sound collecting portion 21 generates voice data indicating an arrival sound and outputs the generated voice data to the voice processing device 10. The voice data is data indicating a waveform of a sound reaching the sound collecting portion 21 and is constituted of time series of signal values sampled using a predetermined sampling frequency (for example, 16 kHz). The sound collecting portion 21 includes an electroacoustic transducer such as, for example, a microphone.

The public address portion 22 plays a sound indicated by voice data input from the voice processing device 10. The public address portion 22 includes, for example, a speaker or the like.

The communication portion 31 is connected to a communication device indicated by device information input from the voice processing device 10 in a wireless or wired manner and communicates with the communication device. The device information includes an internet protocol (IP) address, a telephone number, and the like of a communication device used by the called person. The communication portion 31 includes, for example, a communication module.

The voice processing device 10 includes an input portion 101, a voice recognizing portion 102, a name specifying portion 103, a checking portion 104, a voice synthesizing portion 105, an output portion 106, a data generating portion 108, and a storage portion 110.

The input portion 101 outputs voice data input from the sound collecting portion 21 to the voice recognizing portion 102. The input portion 101 is an input or output interface connected to, for example, the sound collecting portion 21 in a wired or wireless manner.

The voice recognizing portion 102 calculates a predetermined voice feature amount on the basis of voice data input from the input portion 101 at predetermined time intervals (for example, 10 to 50 ms). The calculated voice feature amount is, for example, a 25-dimensional Mel-Frequency Cepstrum Coefficient (MFCC). The voice recognizing portion 102 performs a known voice recognition process on the basis of time series of a voice feature amount constituted of the calculated voice feature amount and generates a phoneme string including phonemes uttered by the speaker. In the voice recognizing portion 102, for example, a hidden Markov model (HMM) is used as an acoustic model used for the voice recognition process, and for example, an n-gram is used as a language model. The voice recognizing portion 102 outputs the generated phoneme string to the name specifying portion 103 and the checking portion 104.

The name specifying portion 103 extracts a phoneme string of a portion of the phoneme string input from the voice recognizing portion 102, in which a name is uttered, using an answer pattern (which will be described later). The name specifying portion 103 calculates an editing distance indicating a degree of similarity between a phoneme string for each name indicated in a first name list (which will be described later) already stored in the storage portion 110 and the extracted phoneme string. A degree of similarity between phoneme strings of comparison targets is higher when the editing distance is shorter, and the degree of similarity between the phoneme strings is lower when the editing distance is longer. The name specifying portion 103 specifies a name corresponding to a phoneme string giving a smallest editing distance as the calculated editing distance. The name specifying portion 103 outputs a phoneme string related to the specified name to the checking portion 104.

The checking portion 104 generates a check message with respect to utterance content represented by a phoneme string input from the voice recognizing portion 102 or the name specifying portion 103. In the checking portion 104, a check message is a message requesting an answer regarding whether the input utterance content is utterance content intended by the speaker. Thus, the checking portion 104 causes the voice synthesizing portion 105 to synthesize the utterance content and voice data of a voice indicating the check message.

For example, when the phoneme string related to an uttered name (which will be described later) is input from the name specifying portion 103, the checking portion 104 reads a check message pattern, which is stored in advance, from the storage portion 110. The checking portion 104 generates a check message by inserting the input phoneme string into the read check message pattern. The checking portion 104 outputs the generated check message to the voice synthesizing portion 105.

When a negative utterance (which will be described later) or a phoneme string indicating a candidate name (which will be described later) is input from the voice recognizing portion 102, the checking portion 104 reads a phoneme string of a candidate name corresponding to a candidate name corresponding to an uttered name indicated in a second name list already stored in the storage portion 110. As a candidate name, a name highly likely to be erroneously recognized is associated with an uttered name thereof in the second name list. The checking portion 104 generates a check message by inserting the read phoneme string of the candidate name into a read check message pattern. The checking portion 104 outputs the generated check message to the voice synthesizing portion 105.

When an affirmative utterance (which will be described later) or a phoneme string of an uttered name (or a phoneme string of a recently input candidate name) is input from the voice recognizing portion 102, the checking portion 104 specifies that the uttered name (or the candidate name of which the phoneme string is recently input) is a correct name of the called person intended by the speaker.

Note that details of a series of voice processes used to check the name of a called person intended by the speaker will be described later.

The checking portion 104 specifies device information of a contact corresponding to a specified name by referring to a contact list already stored in the storage portion 110. The checking portion 104 generates a call command used to start communication with a communication device indicated by the specified device information. The checking portion 104 outputs the generated call command to the communication portion 31. Thus, the checking portion 104 causes the communication portion 31 to start communication with the communication device. The call command may include a call message. In this case, the checking portion 104 reads a call message already stored in the storage portion 110 and transmits the call message, which is read to the communication device, to the communication portion 31. The communication device plays a voice based on a call message indicated by call message voice data received from the checking portion 104. Thus, a user of the voice processing device 10 can call a called person using the communication device via the voice processing device 10. The user mainly may be a visitor or a guest in various types of offices, facilities, and the like. Also, the checking portion 104 reads a standby message already stored in the storage portion 110 and outputs the read standby message to the voice synthesizing portion 105. The voice synthesizing portion 105 generates voice data of a voice with pronunciation represented by a phoneme string indicated by a standby message input from the checking portion 104 and outputs the generated voice data to the public address portion 22 via the output portion 106. For this reason, the user is notified that the called person is being called at this time.

The voice synthesizing portion 105 generates voice data by performing a voice synthesis process on the basis of a phoneme string indicated by a check message input from the checking portion 104. The generated voice data is data indicating a voice with pronunciation represented by the phoneme string. In the voice synthesis process, for example, the voice synthesizing portion 105 generates the voice data by performing formant synthesis. The voice synthesizing portion 105 outputs the generated voice data to the output portion 106.

The output portion 106 outputs voice data input from the voice synthesizing portion 105 to the public address portion 22. The output portion 106 is an input or output interface connected to, for example, the public address portion 22 in a wired or wireless manner. The output portion 106 may be integrally formed with the input portion 101.

The data generating portion 108 generates the second name list obtained by associating a phoneme string indicating a name indicated by the first name list already stored in the storage portion 110 with another name of which an editing distance is shorter than a predetermined editing distance. The data generating portion 108 stores the generated second name list in the storage portion 110. The editing distance is calculated so that degrees (costs) to which any phoneme is changed and recognized in the recognized phoneme string are accumulated. Such a change includes erroneous recognition, insertion, and deletion. The data generating portion 108 may update the second name list on the basis of the phoneme string related to the affirmative utterance and the phoneme string related to the negative utterance acquired by the checking portion 104 (on-line learning).

The storage portion 110 stores data used for a process in an other constitution portion and data generated by the other constitution portion. The storage portion 110 includes a storage medium such as, for example, a random access memory (RAM).

### Erroneous Recognition Between Phonemes

There are largely three types of elements as elements of erroneous recognition between phonemes as will be described later; (1) substitution, (2) insertion, and (3) deletion. (1) The substitution means that a phoneme originally meant to be recognized is recognized as another phoneme. (2) The insertion means that a phoneme not originally meant to be recognized is recognized. (3) The deletion means that a phoneme originally meant to be recognized is not recognized. Thus, the data generating portion 108 acquires phoneme recognition data indicating a frequency of each output phoneme for each input phoneme. The voice recognizing portion 102 generates a phoneme string by performing the voice recognition process with respect to, for example, voice data indicating voices in which various well-known phoneme strings are uttered. Also, the data generating portion 108 matches a well-known phoneme string with a phoneme string generated by the voice recognizing portion 102 and specifies a phoneme recognized for each phoneme constituting the well-known phoneme string. A well-known method such as, for example, a start end free DP matching method, can be used in the matching of the data generating portion 108. The data generating portion 108 counts frequencies of output phonemes for every input phoneme using phonemes constituting the well-known phoneme string as the input phoneme. The output phonemes refer to phonemes included in the phoneme string generated by the voice recognizing portion 102, that is, the recognized phoneme string.

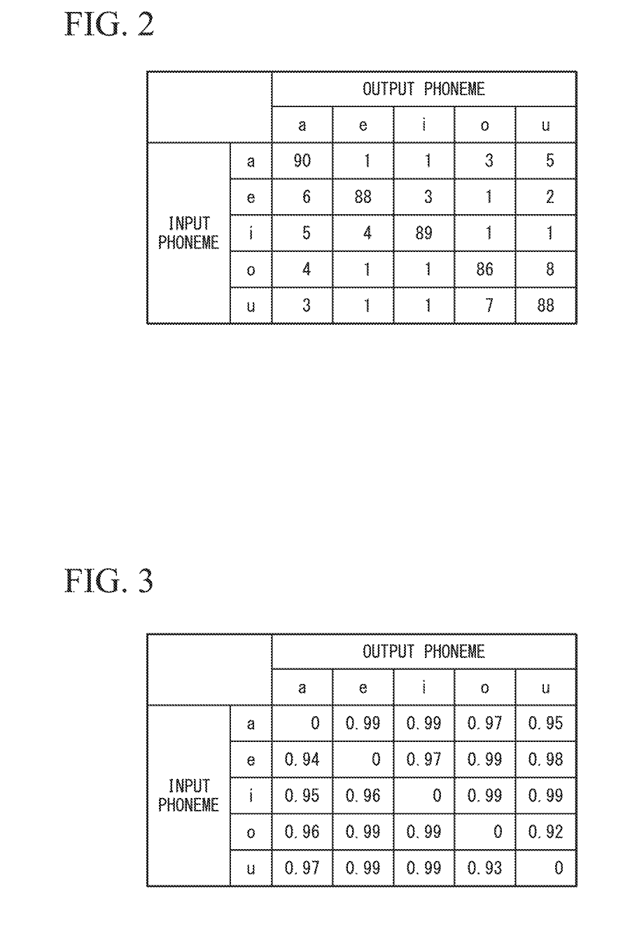

FIG. 2 is a view illustrating an example of phoneme recognition data related to this embodiment. In the example illustrated in FIG. 2, the phoneme recognition data indicates the number of output phonemes recognized for every input phoneme. In an example shown in a third column of FIG. 2, the numbers of times output phonemes /a/, /e/, /i/, /o/, and/u/ are recognized are 90, 1, 1, 3, and 5 with respect to 100 occurrences of an input phoneme /a/. A probability of an input phoneme being correctly recognized as /a/ is 90% and probabilities of the input phonemes being substituted as /e/, /i/, /o/, and /u/ are 1%, 1%, 3%, and 5%. Note that a frequency at which any one 1 of the phonemes is substituted with another phoneme 2 is generally different from a frequency at which the phoneme 2 is substituted with the phoneme 1. Therefore, in the phoneme recognition data, a set of an input phoneme and an output phoneme is distinguished from a set of an input phoneme and an output phoneme in which the output phoneme is the same as the input phoneme. Also, in FIG. 2, when the same phoneme as an input phoneme is recognized (no erroneous recognition), only a case in which the input phoneme is substituted with another phoneme is adopted as an example. The phoneme recognition data includes a column in which there is no corresponding phoneme (d)) as a type of input phoneme and a row in which there is no corresponding phoneme (d)) as a type of output phoneme so that a case such as addition and insertion can be represented.

The data generating portion 108 determines a cost value for each set of the input phoneme and the output phoneme on the basis of the phoneme recognition data. The data generating portion 108 determines a cost value so that the cost value is greater when an occurrence ratio of the set of the input phoneme and the output phoneme is higher. The cost value is a real number normalized so that the cost value has, for example, a value between 0 and 1. For example, a value obtained by subtracting a recognition rate of the set from 1 is used as the cost value. With regard to the set in which the input phoneme is the same as the output phoneme (no erroneous recognition), the data generating portion 108 determines the cost value to be 0. Note that, in the set in which there is no corresponding phoneme (insertion) in the input phoneme, the data generating portion 108 may determine a value obtained by subtracting an occurrence probability of the set from 1 to be the cost value. Also, in the set in which there is no corresponding phoneme (deletion) in the output phoneme, the data generating portion 108 may determine the cost value to be 1 (a highest value) in the set. Thus, deletion is considered to be less likely to occur than substitution or addition.

The data generating portion 108 generates cost data indicating a cost value for each set of the input phoneme and the output phoneme which are determined. FIG. 3 is a view illustrating an example of cost data related to this embodiment.

In the example shown in the third column of FIG. 3, cost values when an input phoneme /a/ is recognized as output phonemes /a/, /e/, /i/, /o/, and /u/ are 0, 0.99, 0.99, 0.97, and 0.95, respectively. The cost value is set to 0 for the correct output phoneme /a/. The cost value is higher for an output phoneme that is erroneously recognized at a lower frequency.

### Editing Distance

The name specifying portion 103 and the data generating portion 108 calculate an editing distance as an example of an index value of a degree of similarity between phoneme strings. The editing distance is a total sum of cost values for every edit necessary until phoneme strings recognized from target phoneme strings are acquired. When the editing distance is calculated, the name specifying portion 103 and the data generating portion 108 refer to cost data stored in the storage portion 110 using phonemes constituting the phoneme string input from the voice recognizing portion 102 as an output phoneme. Phonemes referred to as input phonemes by the name specifying portion 103 and the data generating portion 108 are phonemes constituting a phoneme string for each name stored in the first name list. An edit refers to erroneous recognition of phonemes constituting a phoneme string, that is, elements of erroneous recognition such as substitution from one input phoneme to an output phoneme, deletion of one input phoneme, and insertion of one output phoneme.

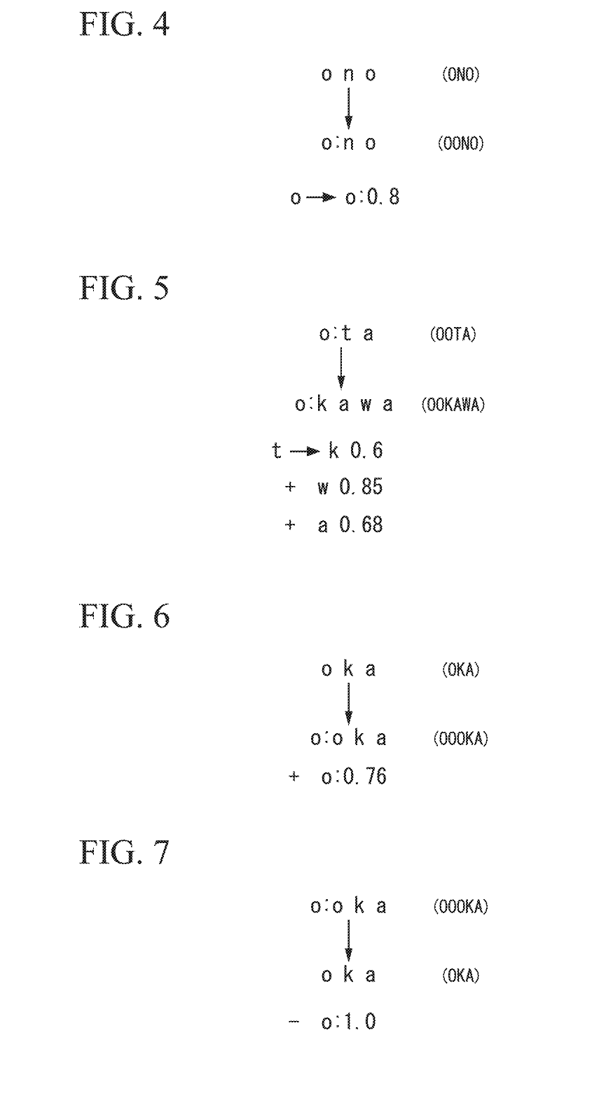

Next, a calculation example of an editing distance will be described using FIGS. 4 to 7.

FIG. 4 is a view illustrating a calculation example (1) of an editing distance of a phoneme string “ono” (ONO) and a phoneme string “o:no” (OONO). The first phoneme /o/ among the phoneme string “ono” is substituted with the phoneme /o:/ and thus the phoneme string “o:no” is formed. A cost value related to substitution from the phoneme /o/ to the phoneme /o:/ is 0.8.

Therefore, the editing distance of the phoneme strings “ono” and “o:no” is 0.8.

FIG. 5 is a view illustrating a calculation example (2) of an editing distance of the phoneme string “o:ta” (OOTA) (a Japanese family name) and the phoneme string “o:kawa” (OOKAWA) (a Japanese family name). The second phoneme /t/ from the beginning among the phoneme string “o:ta” is substituted with the phoneme /k/, and the phonemes /w/, /a/ which are not included in the phoneme string “o:ta” are added (inserted) to the end thereof in that order, and thus the phoneme string “o:kawa” is formed. A cost value related to substitution of the phoneme /k/ with the phoneme /t/, a cost value related to insertion of the phoneme /w/, and a cost value related to insertion of the phoneme /a/ are 0.6, 0.85, and 0.68, respectively. Therefore, an editing distance of the phoneme string “o:ta” and the phoneme string “o:kawa” is 2.13.

FIG. 6 is a view illustrating a calculation example (3) of an editing distance of the phoneme string “oka” (OKA) (a Japanese family name) and the phoneme string “o:oka” (OOOKA) (a Japanese family name). The new phoneme /o:/ is added (inserted) to the beginning of the phoneme string “oka” and thus the phoneme string “o:oka” is formed. A cost value related to insertion of the phoneme /o:/ is 0.76. Therefore, an editing distance of the phoneme string “oka” and the phoneme string “o:oka” is 0.76.

FIG. 7 is a view illustrating a calculation example (4) of an editing distance of the phoneme string “o:oka” (OOOKA) and the phoneme string “oka” (OKA). In the example shown in FIG. 7, in contrast to the example shown in FIG. 6, the first phoneme /o:/ is deleted from the phoneme string “o:oka” and thus the phoneme string “oka” is formed. A cost value related to deletion of the phoneme /o:/ is 1.0. Therefore, an editing distance of the phoneme string “o:oka” and the phoneme string “oka” is 1.0.

The example of erroneous recognition shown in FIG. 7 corresponds to a reverse case of the example shown in FIG. 6. A difference of the editing distance in the example shown in FIG. 6 and the editing distance in the example shown in FIG. 7 is due to the fact that frequencies of occurrence differ in deletion and addition with respect to a common phoneme.

Next, an example of a process of generating the second name list will be described.

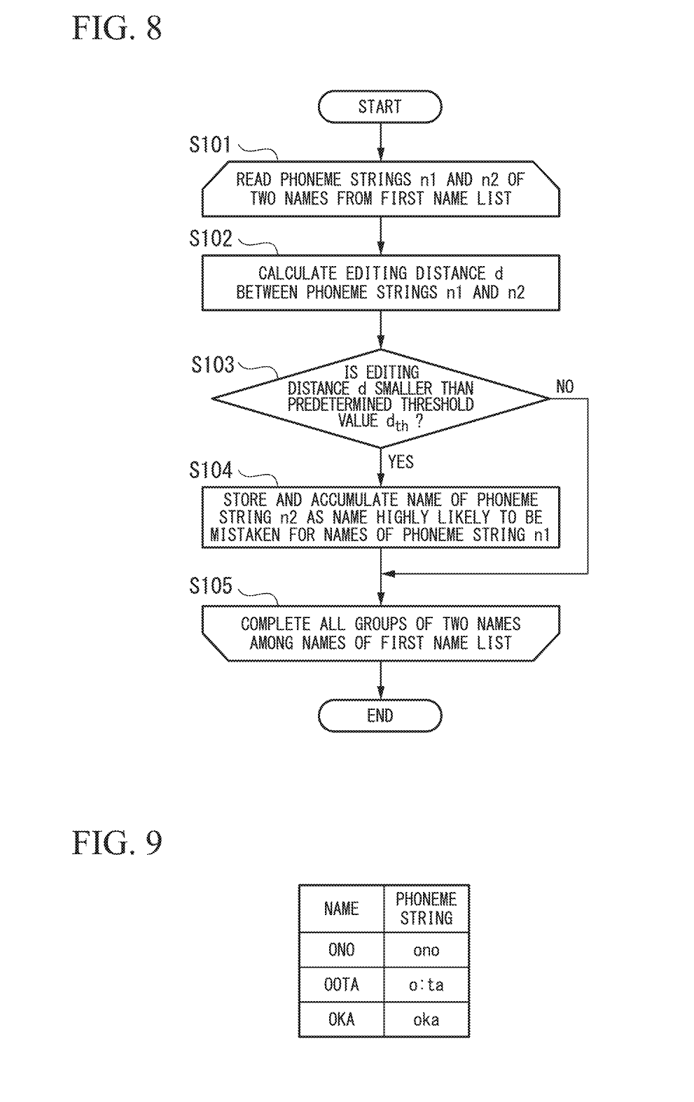

FIG. 8 is a flowchart illustrating the example of the process of generating the second name list related to this embodiment.

(Step S101) The data generating portion 108 reads phoneme strings n1 and n2 of two different names from the first name list already stored in the storage portion 110. For example, the data generating portion 108 reads phoneme strings “o:ta” (OOTA) and “oka” (OKA) from the first name list shown in FIG. 9. Subsequently, the process proceeds to a process of Step S102.
(Step S102) The data generating portion 108 calculates an editing distance d between the read phoneme strings n1 and n2. Subsequently, the process proceeds to a process of Step S103.
(Step S103) The data generating portion 108 determines whether the calculated editing distance d is smaller than a threshold value dₜₕ of a predetermined editing distance. When the calculated editing distance d is determined to be smaller (YES in Step S103), the process proceeds to a process of Step S104. When the calculated editing distance d is determined not to be smaller (NO in Step S103), the process proceeds to a process of Step S105.
(Step S104) The data generating portion 108 determines that a name related to the phoneme string n2 is highly likely to be mistaken for a name related to the phoneme string n1. The data generating portion 108 associates the name related to the phoneme string n1 with the name related to the phoneme string n2 and stores the association in the storage portion 110. Data obtained by accumulating the name related to the phoneme string n2 for each name related to the phoneme string n1 in the storage portion 110 forms the second name list. Subsequently, the process proceeds to a process of Step S105.
(Step S105) The data generating portion 108 determines whether the process of Steps S101 to S104 has been performed on all groups of two names among names stored in the first name list. When there is another group in which the process of Steps S101 to S104 has not ended, the data generating portion 108 performs the process of Steps S101 to S104 on each group in which the process has not ended. When the process of Steps S101 to S104 has been performed on all of the groups, the process shown in FIG. 8 ends.

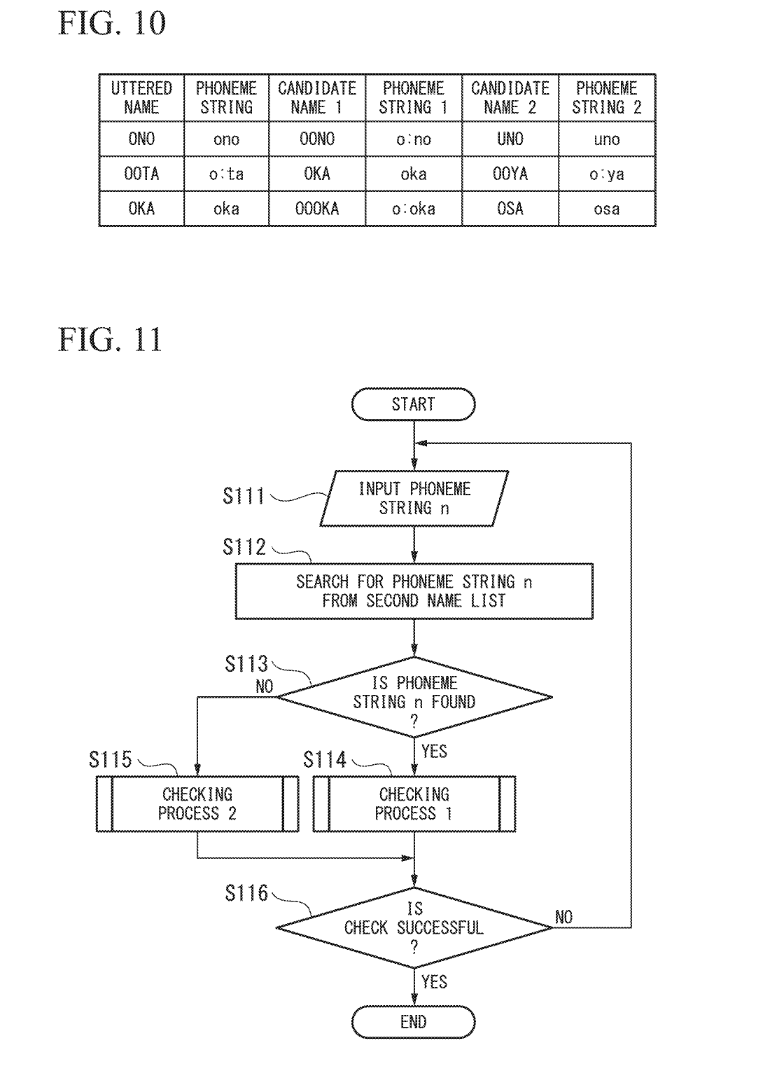

FIG. 10 is a view illustrating an example of a second name list related to this embodiment.

In the example illustrated in FIG. 10, the second name list is formed where a name related to a phoneme string n1 as a candidate name 1 a name related to a phoneme string n2 as a candidate name 2 is associated with an uttered name. The uttered name is a name specified by the name specifying portion 103 with respect to a name uttered by the user on the basis of a phoneme string acquired by the voice recognizing portion 102. The candidate name is a name likely to be erroneously recognized as the uttered name, that is, a candidate for a name intended by the user.

In FIG. 10, the candidate name 1 and the candidate name 2 are indexes used to distinguish a plurality of candidate names from each other. In a second column of FIG. 10, a candidate name 1 “OONO” with a phoneme string 1 “o:no” and a candidate name 2 “UNO” (a Japanese family name) with a phoneme string 2 “uno” are associated with an uttered name “ONO” with a phoneme string “ono.” In the example shown in FIG. 10, two candidate names are associated with each uttered name. However, generally, the number of candidate names associated with each uttered name is different for each uttered name. When there are a plurality of candidate names, the data generating portion 108 arranges the plurality of candidate names in ascending order of editing distance of the phoneme string n1 related to the uttered name and the phoneme string n2 related to the candidate name. In this case, the data generating portion 108 can immediately and sequentially select other candidate names in ascending order of editing distance.

### Voice Process

Next, an example of a voice process related to this embodiment will be described. In the following description, a case in which the voice processing device 10 is applied to recognize the name of a called person from a voice uttered by the user and to check the recognized name of the called person is exemplified. FIG. 11 is a flowchart showing an example of a voice process related to this embodiment. The checking portion 104 reads an initial message already stored in the storage portion 110 and outputs the read initial message to the voice synthesizing portion 105. The initial message includes a message used to request the user to utter the name of the called person.

(Step S111) A phoneme string n is input from the name specifying portion 103 within a predetermined period of time (for example, 5 to 15 seconds) after the initial message is output. The phoneme string n is a phoneme string related to a name specified by the name specifying portion 103 on the basis of a phoneme string input from the voice recognizing portion 102. Subsequently, the process proceeds to a process of Step S112.
(Step S112) The checking portion 104 searches for an uttered name with a phoneme string coinciding with the phoneme string n by referring to the second name list stored in the storage portion 110. Subsequently, the process proceeds to a process of Step S113.
(Step S113) The checking portion 104 determines whether the uttered name with the phoneme string coinciding with the phoneme string n is found. When the uttered name is found (YES in Step S113), the process proceeds to a process of Step S114. When the uttered name is determined not to be found (NO in Step S113), the process proceeds to a process of Step S115.
(Step S114) The checking portion 104 performs a checking process 1 which will be described later. Subsequently, the process proceeds to a process of Step S116.
(Step S115) The checking portion 104 performs a checking process 2 which will be described later. Subsequently, the process proceeds to the process of Step S116.
(Step S116) When the uttered name is determined to be successfully checked in the checking process 1 or the checking process 2 (YES in Step S116), the checking portion 104 ends the process shown in FIG. 11. When the uttered name is determined not to be successfully checked in the checking process 1 or the checking process 2 (NO in Step S116), the process of the checking portion 104 returns to the process of Step S111. Note that, before the process of the checking portion 104 returns to the process of Step S111, the checking portion 104 reads a repeat request message from the storage portion 110 and outputs the read repeat request message to the voice synthesizing portion 105. The repeat request message includes a message used to request the user to utter the name of the called person again.

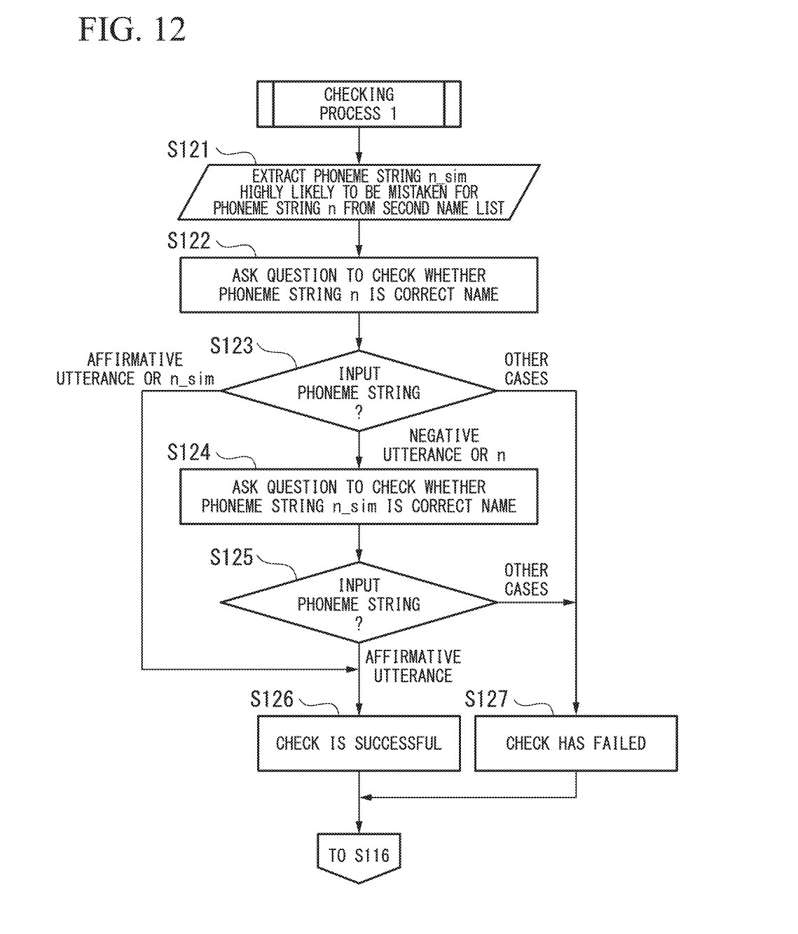

FIG. 12 is a flowchart showing the checking process 1 performed in Step S114 of FIG. 11.

(Step S121) The checking portion 104 reads a phoneme string n_sim related to a candidate name corresponding to the phoneme string n found in Step S113 from the second name list stored in the storage portion 110. The phoneme string n_sim is a phoneme string highly likely to be mistaken for the phoneme string n. Subsequently, the process proceeds to a process of Step S122.
(Step S122) The checking portion 104 reads a check message pattern from the storage portion 110. The checking portion 104 generates a check message by inserting the phoneme string n into the check message pattern. The generated check message is a message indicating a question to check whether the phoneme string n is a phoneme string of a correct name intended by the user. The checking portion 104 outputs the generated check message to the voice synthesizing portion 105. Subsequently, the process proceeds to a process of Step S123.
(Step S123) A phoneme string indicating utterance content is input from the voice recognizing portion 102 to the checking portion 104 within a predetermined period of time (for example, 5 to 10 seconds) after the check message is output. When the input phoneme string is the same as a phoneme string of an affirmative utterance or the phoneme string n_sim (the affirmative utterance or n_sim in Step S123), the process proceeds to a process of Step S126. The affirmative utterance is an answer affirming a message presented immediately before. The affirmative utterance corresponds to an utterance such as, for example, “yes” or “right.” In other words, a case in which the process proceeds to the process of Step S126 corresponds to a case in which the user affirmatively utters that the recognized name related to the phoneme string is the correct name intended by the user. When the input phoneme string is the same as a phoneme string of a negative utterance or the phoneme string n (the negative utterance or n in Step S123), the process proceeds to a process of Step S124. In other words, a case in which the process proceeds to the process of Step S124 corresponds to a case in which the user negatively utters that the recognized name related to the phoneme string is not the correct name intended by the user. When the input phoneme string is another phoneme string (Other cases in Step S123), the process proceeds to a process of Step S127.
(Step S124) The checking portion 104 reads the check message pattern from the storage portion 110. The checking portion 104 generates a check message by inserting the phoneme string n_sim into the check message pattern. The generated check message indicates a question regarding whether the phoneme string n_sim is the phoneme string of the correct name intended by the user. The checking portion 104 outputs the generated check message to the voice synthesizing portion 105. Subsequently, the process proceeds to a process of Step S125.
(Step S125) A phoneme string indicating utterance content is input from the voice recognizing portion 102 to the checking portion 104 within a predetermined period of time (for example, 5 to 10 seconds) after the check message is output. When the input phoneme string is the same as the phoneme string of the affirmative utterance (Affirmative utterance in Step S125), the process proceeds to a process of Step S126. In other words, a case in which the process proceeds to the process of Step S126 corresponds to a case in which the user affirmatively utters that the phoneme string of the name uttered by the user is the phoneme string n_sim. When the input phoneme string is another phoneme string (Other cases in Step S125), the process proceeds to a process of Step S127.
(Step S126) The checking portion 104 determines that a check regarding whether a phoneme string of a name to be lastly processed is the phoneme string of the name intended by the user is successful. Subsequently, the process proceeds to the process of Step S116 (FIG. 11).
(Step S127) The checking portion 104 determines that the check regarding whether the phoneme string of the name to be lastly processed is the phoneme string of the name intended by the user has failed. Subsequently, the process proceeds to the process of Step S116 (FIG. 11).

Note that, in the process shown in FIG. 12, a case in which only one phoneme string n_sim of the candidate name is associated with the phoneme string n related to the uttered name in the second name list is exemplified. However, two or more phoneme strings of the candidate name may be associated with the phoneme string n in some cases. In this case, when the input phoneme string is determined to be the phoneme string of the negative utterance or the phoneme string n in Step S123, the checking portion 104 repeatedly performs the process of Step S122 and the process of Step S123 on unprocessed phoneme strings of the candidate name between a first candidate name and a second candidate name from the last candidate name instead of the phoneme string n. Here, when the input phoneme string is the same as the phoneme string of the negative utterance in Step S123, the process of the checking portion 104 returns to the process of Step S122. Also, even if the input phoneme string is the same as any unprocessed phoneme string of the candidate name different from the candidate name to be processed in Step S123, the process of the checking portion 104 returns to the process of Step S122. In this case, the checking portion 104 performs the process of Step S122 on the phoneme string instead of the phoneme string n. Repetition of the process ends when the process is determined to proceed to the process of Step S126 or S127 in Step S123. Also, the checking portion 104 performs the process of Step S124 and the process of Step S125 on the last phoneme string. Therefore, the success or failure of the check is determined in the order of likelihood of the phoneme strings of the candidate name to be mistaken for the phoneme string n. An order of the repetition of the process is an order in which the candidate names are arranged in the second name list.

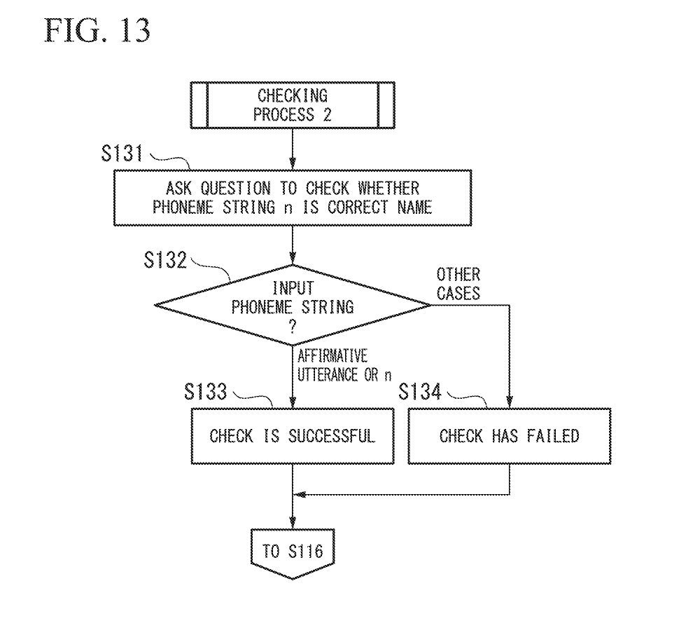

FIG. 13 is a flowchart of the checking process 2 performed in Step S114 of FIG. 11.

(Step S131) The checking portion 104 performs the same process as in Step S122. Subsequently, the process proceeds to a process of Step S132.
(Step S132) A phoneme string indicating utterance content is input from the voice recognizing portion 102 to the checking portion 104 within a predetermined period of time (for example, 5 to 10 seconds) after the check message is output. When the input phoneme string is the same as the phoneme string of the affirmative utterance or the phoneme string n (Affirmative utterance or n in Step S132), the process proceeds to a process of Step S133. When the input phoneme string is another phoneme string (Other cases in Step S132), the process proceeds to a process of Step S134.
(Step S133) The checking portion 104 determines that a check regarding whether a phoneme string n of a name to be lastly processed is the phoneme string of the name intended by the user is successful. Subsequently, the process proceeds to the process of Step S116 (FIG. 11).
(Step S134) The checking portion 104 determines that the check regarding whether the phoneme string n of the name to be lastly processed is the phoneme string of the name intended by the user has failed. Subsequently, the process proceeds to the process of Step S116 (FIG. 11).

Therefore, according to FIGS. 11 to 13, repetition of playing of a check message of a name serving as a recognition result and an utterance used to correct the check message by the user is avoided. For this reason, the voice processing device 10 can more smoothly specify a name intended by the user.

In Steps S123 and S125 of FIG. 12 and Step S132 of FIG. 13, the phoneme string may not be input from the voice recognizing portion 102 to the checking portion 104 over a predetermined period of time (for example, 5 to 10 seconds) after an output of the check message in some cases. In this case, the process of the checking portion 104 proceeds to the process of Step S126, S126, or S133, and it may be determined that the check is successful. Thus, even if the user does not utter to the check message, the recognition result is treated as accepted. Even in this case, repetition of playing of a check message of a name serving as a recognition result and an utterance used to correct the check message by the user is avoided.

### Message

Next, various messages and message patterns used for an interactive process by the voice processing device 10 will be described. The interactive process includes a voice process shown in FIG. 11 and a checking process shown in FIGS. 12 and 13. The storage portion 110 stores various messages and message patterns in advance. Hereinafter, the messages and the message patterns are referred to as a message or the like.

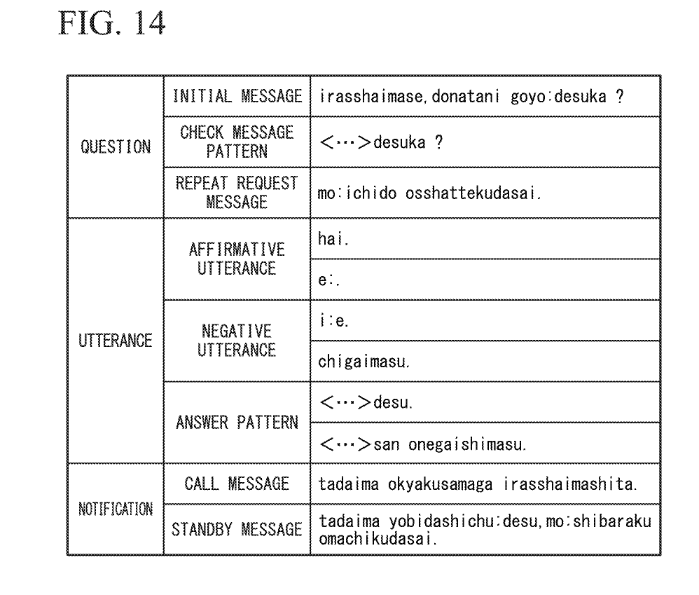

FIG. 14 is a view illustrating an example of the message or the like related to this embodiment.

The message or the like is data representing information of a phoneme string indicating pronunciation thereof. A message is data representing information of a phoneme string interval indicating pronunciation thereof. A message pattern is data including information of a phoneme string interval indicating pronunciation thereof and information of an insertion interval. The insertion interval is an interval during which a phoneme string of another phrase can be inserted. The insertion interval is an interval within angle brackets “<” and “>” in FIG. 14. A series of phoneme strings obtained by integrating the phoneme string interval and the phoneme string inserted into the insertion interval indicates pronunciation of one message.

Messages or the like related to this embodiment are divided into three types of elements: a question message, an utterance message, and a notification message. The question message is a message or the like used for playing a voice of a question regarding the user by the voice processing device 10. The utterance message is a message or the like used for specifying a phoneme string by matching a phoneme string of utterance content of the user.

The specified result is used for controlling an operation of the voice processing device 10. The notification message is a message or the like used for notifying the user or the called person serving as a user of an operation condition of the voice processing device 10.

The question message includes an initial message, a check message pattern, and a repeat request message. The initial message is a message used for requesting the user to utter the name of the called person the user is visiting. In the example shown in the first column of FIG. 14, the initial message is the expression “irasshaimase, donatani goyo:desuka?” (Welcome, who would you like to speak to?).

The check message pattern is a message pattern used for generating a message used for requesting the user to utter an answer regarding whether a phoneme string recognized from an utterance made immediately before (for example, within 5 to 15 seconds from that point in time) is content intended by the user serving as a speaker. In the example of the second column of FIG. 14, the check message pattern is the expression “< . . . > desuka?” (Is < . . . > correct?). The expression “< . . . >” corresponds to an insertion interval during which the recognized phoneme string is inserted.

The repeat request message is a message used for requesting the user serving as the speaker to utter the name of the called person again. In the example shown in the third column of FIG. 14, the repeat request message is the expression “mo:ichido osshattekudasai” (Could you please repeat that?).

The utterance message includes an affirmative utterance, a negative utterance, and an answer pattern. The affirmative utterance indicates a phoneme string of an utterance used for affirming content of a message made immediately before. In the examples of the fourth and fifth columns of FIG. 14, the affirmative utterance is the expression “hai” (Yes) or “ee” (Right). The negative utterance indicates a phoneme string of an utterance used for disaffirming content of the message made immediately before. In the examples shown in the sixth and seventh columns of FIG. 14, the negative utterance is the expression “iie” (No) or “chigaimasu” (Not).

The answer pattern is a message pattern including an insertion interval used for extracting a phoneme string as an answer to the check message from an utterance of the user serving as the speaker. The phoneme string included in the answer pattern formally appears in a sentence including answer content and corresponds to a phoneme string of an unnecessary utterance as the answer content. The insertion interval indicates a portion in which the answer content is included. In this embodiment, a phoneme string of the name of the called person is needed as the answer content. In the examples shown in the eighth and ninth columns of FIG. 14, the answer pattern is the expression “< . . . > desu” (< . . . > is correct) or “< . . . > san onegaishimasu” (Could I speak to < . . . >?). These messages are used when the name specifying portion 103 and the checking portion 104 match one of these messages with a phoneme string input from the voice recognizing portion 102 and acquire a phoneme string of a name serving as answer content from the matched phoneme string. A well-known method such as, for example, a start end free DP matching method can be used in the matching.

The notification message includes a call message and a standby message. The call message is a message used for notifying the called person that the user is visiting. In the example shown in the tenth column of FIG. 14, the call message is the expression “tadaima okyakusamaga irasshaimashita” (A client visits you). The standby message is a message used for notifying the user that the called person is being called. In the example shown in the eleventh column of FIG. 14, the standby message is the expression “tadaima yobidashichu:desu, mo:shibaraku omachikudasai” (Now calling. Please wait.).

### Modified Example

Next, a modified example of this embodiment will be described. In one modified example, a data generating portion 108 may update phoneme recognition data on the basis of a checking process shown in FIGS. 12 and 13. The data generating portion 108 determines that phonemes constituting a phoneme string successfully checked in Step S116 or S126 are phonemes which are correctly recognized. The data generating portion 108 matches a phoneme string which has failed to be checked in Step S127 with a phoneme string determined to be successfully checked before the phoneme string is determined to be successfully checked in Step S116 or S126. The data generating portion 108 determines phonemes which are common between a phoneme string determined to be successfully checked and a phoneme string determined to have failed to be checked to be a phonemes which are correctly recognized. The data generating portion 108 determines phonemes included in the phoneme string determined to have failed to be checked among different phonemes between the phoneme string determined to be successfully checked and the phoneme string determined to have failed to be checked to be input phonemes, and determines that phonemes included in the phoneme string determined to be successfully checked are output phonemes which are not correctly recognized. Thus, it is determined that the output phonemes which are not correctly recognized are erroneously recognized as output phonemes different from the input phonemes. Also, the data generating portion 108 accumulates the number of occurrences of the phonemes which are correctly recognized by adding the numbers of occurrences of the phonemes which are correctly recognized to the numbers of times the phonemes are the output phonemes using the phonemes as input phonemes. The data generating portion 108 adds the numbers of occurrences of output phonemes erroneously recognized as input phonemes which are not correctly recognized to the numbers of times the input phonemes are the output phoneme. With regard to addition and deletion serving as elements of erroneous recognition, the data generating portion 108 accumulates the numbers of occurrences of output phonemes to be added or the numbers of occurrences of input phonemes to be deleted as the number in which there is no input phoneme or output phoneme. Thus, phoneme recognition data representing the numbers of times the output phonemes are recognized for each input phoneme is updated.

Subsequently, the data generating portion 108 updates cost data indicating a cost value for each set of the input phoneme and the output phoneme using the updated phoneme recognition data. The data generating portion 108 performs the generating process shown in FIG. 8 by referring to a first name list and the updated cost data. Thus, a second name list is updated. The updated second name list is used for the voice process shown in FIG. 11 and the checking process 1 shown in FIG. 12. Therefore, the phoneme recognition data is updated on the basis of the success or failure of the phoneme string in the voice process and the checking processes 1 and 2, and the second name list is used for the voice process and the checking process 1 on the basis of the updated phoneme recognition data. The second name list having a name that is highly likely to be erroneously recognized in accordance with recognition of a phoneme string depending on a usage environment as a candidate name is updated. Since the candidate name determined in accordance with the usage environment is preferentially presented as a more reliable candidate for a called person, a name intended by a visitor serving as a user can be smoothly specified.

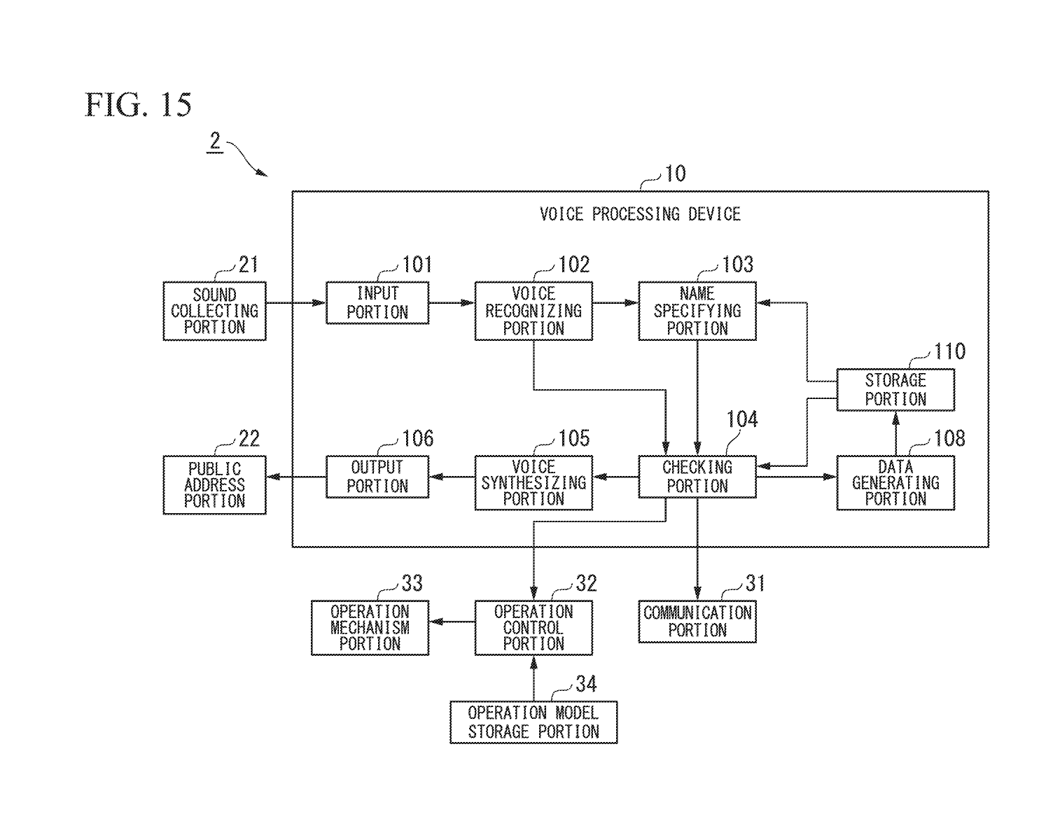

A voice processing system 2 related to another modified example of this embodiment may be constituted as a robotic system. FIG. 15 is a block diagram showing the voice processing system 2 related to this modified example.

The voice processing system 2 related to this modified example is constituted as a single robotic system including a voice processing device 10, a sound collecting portion 21, a public address portion 22, and a communication portion 31, in addition to an operation control portion 32, an operation mechanism portion 33, and an operation model storage portion 34.

A storage portion 110 further associates robot command information used to instruct a robot to perform an operation for each operation of the robot with a phoneme string of a phrase indicating the operation and stores the association. A checking portion 104 matches an input phoneme string from a voice recognizing portion 102 and a phoneme string for each operation and specifies an operation related to a phoneme string with a highest degree of similarity. The checking portion 104 may use the above-described editing distance as an index value of a degree of similarity. The checking portion 104 reads the specified robot command information related to the operation from the storage portion 110 and outputs the read robot command information to the operation control portion 32.

The operation model storage portion 34 stores power model information obtained by associating time series data of a power value for each operation in advance. The time series data of the power value is data indicating a power value supplied to a mechanism portion constituting the operation mechanism portion 33. The mechanism portion includes, for example, a manipulator, a multi-finger grasper, and the like. In other words, the power value indicates a magnitude of power consumed when the mechanism portion performs the operation for each operation.

The operation control portion 32 reads power model information of an operation related to robot command information, which is input from the checking portion 104, from the operation model storage portion 34. The operation control portion 32 supplies the mechanism portion with an amount of power indicated by time series data represented by the read operation model information. The operation mechanism portion 33 performs an operation according to robot command information regarding an instruction uttered by the user when the mechanism portion receiving power supplied from the operation control portion 32 operates while consuming the power.

Note that, also with regard to a robot command representing a title of an operation performed on the robot, a data generating portion 108 may generate a robot command list representing robot commands highly likely to be erroneously recognized as in a name. Also, also with regard to the robot command, the checking portion 104 may perform the voice process shown in FIG. 11 using the generated robot command list.

Thus, repetition of playing of a check message of a command serving as a recognition result and an utterance used to correct the check message by the user is avoided.

As described above, the voice processing device 10 related to this embodiment includes the voice recognizing portion 102 configured to recognize a voice and to generate a phoneme string. The voice processing device 10 includes the storage portion 110 configured to store a first name list representing phoneme strings of first names (uttered names) and a second name list obtained by associating a phoneme string of a predetermined first name among the first names with a phoneme string of a second name (a candidate name) similar to the phoneme string of the first name. The voice processing device 10 includes the name specifying portion 103 configured to specify a name indicated by an uttered voice on the basis of a degree of similarity between the phoneme string of the first name and the phoneme string generated by the voice recognizing portion 102. Also, the voice processing device 10 includes a voice synthesizing portion 105 configured to synthesize a voice of a message and the checking portion 104 configured to cause the voice synthesizing portion to synthesize a voice of a check message used for requesting the user to utter an answer regarding whether the name is a correct name. The checking portion 104 causes the voice synthesizing portion 105 to synthesize the voice of the check message with respect to a name specified by the name specifying portion 103, and selects a phoneme string of a second name (a candidate name) corresponding to a phoneme string of the name (an uttered name) specified by the name specifying portion 103 by referring to the second name list when the user answers that the name specified by the name specifying portion is not a correct name. Also, the checking portion 104 causes the voice synthesizing portion 105 to synthesize the voice of the check message with respect to the selected second name.

With such a constitution, a name similar in pronunciation to a recognized name is selected by referring to the second name list. Even if the recognized name is disaffirmed by the user, the selected name is presented as a candidate for the name intended by the user. For this reason, the name intended by the user is highly likely to be specified quickly. Also, repetition of playing of a check voice of a recognition result and an utterance used to correct a check result is avoided. For this reason, the name intended by the user is smoothly specified.

The phoneme string of the second name included in the second name list stored in the storage portion 110 is a phoneme string with a possibility of causing the second name to be erroneously recognized as the first name higher than a predetermined possibility.

With such a constitution, even if the uttered name is erroneously recognized as the first name, the second name is selected as a candidate for the specified name. For this reason, the name intended by the user is highly likely to be specified.

An editing distance between the phoneme string of the second name associated with the phoneme string of the first name in the second name list and the phoneme string of the first name is smaller than a predetermined editing distance.

With such a constitution, a second name with a pronunciation which is quantitatively similar to the pronunciation of the first name as the second name is selected as a candidate for the specified name. For this reason, a name with a pronunciation similar to that of the name which is erroneously recognized is highly likely to be specified as the name intended by the user.

The checking portion 104 preferentially selects a second name related to a phoneme string in which the editing distance from the phoneme string of the first name is small.

With such a constitution, when there are a plurality of second names corresponding to the first name, a second name similar in pronunciation to the first name is preferentially selected. Since a name similar in pronunciation to the name which is erroneously recognized is preferentially presented, the name intended by the user is highly likely to be specified early.

The phoneme string of the second name is obtained according to at least one of substitution of some of the phonemes constituting the phoneme string of the first name with other phonemes, insertion of other phonemes, and deletion of some of the phonemes as elements of erroneous recognition of the phoneme string of the first name. The editing distance is calculated so that cost values related to the elements of erroneous recognition are accumulated.

With such a constitution, a small editing distance is calculated because a change in a phoneme string according to erroneous recognition is simple. For this reason, the name similar in pronunciation to the name which is erroneously recognized is quantitatively determined.

As the cost values, low values are determined when frequencies of the elements of erroneous recognition are high.

With such a constitution, the name related to the phoneme string highly likely to be erroneously recognized as the phoneme string of the first name is selected as the second name. For this reason, the name intended by the user is highly likely to be specified as the second name.

While embodiments of the present invention have been described above in detail with reference to the drawings, specific constitutions thereof are not limited to the above-described embodiments. In addition, changes in design, and the like are also included without departing from the gist of the present invention. The constitutions described in the above-described embodiments can be arbitrarily combined.

For example, in the above-described embodiments, although a case in which a phoneme, a phoneme string, a message, and a message pattern in Japanese are used is exemplified, the present invention is not limited thereto. In the above-described embodiments, phonemes, phoneme strings, messages, and message patterns in another language, for example, English, may be used.

In the above-described embodiments, although a case in which a name is mainly the surname of a natural person is exemplified, the present invention is not limited thereto. The given name or the full name may be used instead of the surname. Also, a name is not necessarily limited to the name of a natural person, and an organization name, a department name, or their common names may be used. A name is not limited to an official name or a real name and may be an assumed name such as a common name, a nickname, a diminutive, or a pen name. A called person is not limited to a specific natural person and may be a member of an organization, a department, or the like.

The voice processing device 10 may be constituted by integrating one, two, or all of the sound collecting portion 21, the public address portion 22, and the communication portion 31.

Note that a portion of the voice processing device 10 in the above-described embodiments, for example, the voice recognizing portion 102, the name specifying portion 103, the checking portion 104, the voice synthesizing portion 105, and the data generating portion 108 may be realized using a computer. In this case, a program for realizing a control function is recorded on a computer-readable recording medium, and the program recorded on the recording medium is read by and executed in a computer system so that they may be realized. Note that “the computer system” described herein refers to a computer system built in the voice processing device 10 and is assumed to include an operating system (OS) and hardware such as peripheral devices. “The computer-readable recording medium” refers to a portable medium such as a flexible disk, a magneto optical disc, a read-only memory (ROM), or a compact disc read-only memory (CD-ROM), and a storage device such as a hard disk built in a computer system. “The computer-readable recording medium” may include a medium configured to dynamically hold a program during a short period of time, such as a communication line when the program is transmitted via a network such as the Internet or a communication circuit such as a telephone line, and a medium configured to hold a program during a certain period of time, such as a volatile memory inside a computer system serving as a server or a client in that case. The above-described program may be a program for realizing some of the above-described functions and may be a program in which the above-described functions can be realized through a combination of the program with a program already recorded on a computer system.

The voice processing device 10 in the above-described embodiments may be partially or entirely realized as an integrated circuit such as a large scale integration (LSI).

Functional blocks of the voice processing device 10 may be individually constituted as a processor and may be partially or entirely integrated to be constituted as a processor. A method of realizing the functional blocks as a processor is not limited to LSI, and the functional blocks may be realized using a dedicated circuit or a general purpose processor. Also, when technology for realizing the functional blocks as an integrated circuit instead of LSI appears with advances in semiconductor technology, an integrated circuit using the corresponding technology may be used.

Embodiments of the present invention have been described above in detail with reference to the drawings, but specific constitutions thereof are not limited to the above-described embodiments, and various changes in design and the like are possible without departing from the gist of the present invention.

What is claimed is:

1. A voice processing device comprising:
a voice recognizing portion configured to recognize a voice and to generate a phoneme string;
a storage portion configured to store a first name list indicating phoneme strings of first names and a second name list obtained by associating a phoneme string of a predetermined first name among the first names with a phoneme string of a second name similar to the phoneme string of the first name;
a name specifying portion configured to specify a name indicated by the voice on the basis of a degree of similarity between the phoneme string of the first name and the phoneme string generated by the voice recognizing portion;
a voice synthesizing portion configured to synthesize a voice of a message; and
a checking portion configured to cause the voice synthesizing portion to synthesize a voice of a check message used to request an answer regarding whether the name specified by the name specifying portion is a correct name,
wherein the checking portion causes the voice synthesizing portion to synthesize the voice of the check message with respect to the name specified by the name specifying portion,
when a user answers that the name specified by the name specifying portion is not the correct name, a phoneme string of a second name corresponding to a phoneme string of the name specified by the name specifying portion is selected by referring to the second name list, and
the voice synthesizing portion is caused to synthesize the voice of the check message with respect to the selected second name.

2. The voice processing device according to claim 1, wherein a phoneme string of a second name included in the second name list is a phoneme string with a possibility of causing the phoneme string of the second name to be erroneously recognized as the phoneme string of the first name higher than a predetermined possibility.

3. The voice processing device according to claim 1, wherein a distance between the phoneme string of the second name associated with the phoneme string of the first name in the second name list and the phoneme string of the first name is shorter than a predetermined distance.

4. The voice processing device according to claim 3, wherein the checking portion preferentially selects the second name related to a phoneme string in which the distance from the phoneme string of the first name is small.

5. The voice processing device according to claim 3, wherein the phoneme string of the second name is obtained according to at least one of substitution of some of phonemes constituting the phoneme string of the first name with other phonemes, insertion of other phonemes, and deletion of some of the phonemes as elements of erroneous recognition of the phoneme string of the first name, and
the distance is calculated to accumulate a cost related to the elements.

6. The voice processing device according to claim 5, wherein the cost is set so that a value thereof decreases as a number of the elements of erroneous recognition increases.

7. A voice processing method in a voice processing device including a storage portion configured to store a first name list indicating phoneme strings of first names and a second name list obtained by associating a phoneme string of a predetermined first name among the first names with a phoneme string of a second name similar to the phoneme string of the first name, wherein
the voice process device has:
a voice recognition step of recognizing a voice and generating a phoneme string;
a name specifying step of specifying a name indicated by the voice on the basis of a degree of similarity between the phoneme string of the first name and the phoneme string generated in the voice recognition step; and
a check step of causing a voice synthesizing portion to synthesize a voice of a check message used to request an answer regarding whether the name specified in the name recognition step is a correct name, and
the check step has:
a step of causing the voice synthesizing portion to synthesize the check message with respect to the name specified in the name recognition step;
a step of selecting a phoneme string of a second name corresponding to a phoneme string of the name specified in the name recognition step by referring to the second name list when a user answers that the name specified in the name recognition step is not the correct name; and
a step of causing the voice synthesizing portion to synthesize the voice of the check message with respect to the selected second name.
